(19) United States
(12) Patent Application Publication
(10) Pub. No.: US 2003/0063580 A1
(43) Pub. Date: Apr. 3, 2003

(54) Packetized voice messaging

(76) Inventor: Russell Pond, Euless, TX (US)

Correspondence Address: NOVAKOV DAVIS & MUNCK, A PROFESSIONAL CORPORATION, 900 THREE GALLERIA TOWER, 13155 NOEL ROAD, Dallas, TX, 75240, US

(21) Appl. No.: 09/967,070

(22) Filed: Sep. 28, 2001

(51) Int. Cl. H04Q 7/00

(52) U.S. Cl. 370/328

(57) ABSTRACT

A system and method for sending short voice-mail service (SVMS) messages through a wireless radio telecommunications network. An SVMS message is a brief packet data message that is sent through a data channel in the wireless network. An SVMS-MSC receives SVMS messages through an SVMS-gateway, stores them, and then identifies the intended recipient. When the SVMS-MSC identifies the intended recipient and determines their location, it transmits the SVMS message to them. The SVMS message will typically be generated by one mobile station capable of enhanced SVMS-MSC 270 communication (such as a GPRS-enabled mobile station). If the intended recipient is determined by the SVMS-MSC to be incapable of receiving SVMS messages, then the SVMS-MSC may attempt delivery by alternate means.

The present invention relates generally to message delivery in wireless radio telecommunication networks and, more specifically, to a system and method for the efficient transmission of short, packet-formatted voice messages to and from mobile stations in communication with such a network.

### BACKGROUND OF THE INVENTION

Telephone systems have improved greatly in recent years. The public switched telephone network (PSTN), itself a vast improvement over previous forms of communication, has evolved from an infancy that featured low-capacity local switching offices staffed by human operators, to modem, highly automated long-distance systems. Not only has the original PSTN been supplemented with automatic switching devices and trans-Atlantic cables, but its transmission quality has became sufficient to support digital-data communication applications such as facsimile and computer networking. For most purposes, however, subscribers (that is, the users of a telephone system) have been until recently limited to wireline phones—meaning that their communications terminals had to be used from a more or less fixed location. Although radio (and thus more mobile) communication has existed for some time, its application for ordinary telephone users did not emerge immediately.

The advent of cellular technology, however, has opened up radio telephone applications to many more subscribers. Through the implementation of limited-range radio transceivers that communicate with nearby base stations, radio communication frequencies could easily be reused from one base-station covered area (or “cell”) to another without undue interference. This strategy permitted the operation of literally hundreds of mobile, “cellular” phones within a given metropolitan area. Cellular technology further includes the network capability of allowing mobile telephone phone users to move from one cell to another (and hence from one base station to another) without an interruption in service. The mobile phones were thus truly mobile.

As alluded to previously, on the wireline side service has long since moved beyond simple voice communication. Eventually, even digital computers were able to communicate with each other over the PSTN to form a computer network. Of course, computers connected together into a network had always been able to communicate with each other, but initially this communication had been generally limited to computers operating at the same facility and connected by cables dedicated for this purpose. Eventually, high-capacity dedicated telephone lines were employed to permit networked computers to be located distant from one another. With the advent of personal computers having modems, however, computer communication over the ordinary PSTN became possible. When the Internet became widely accessible, communication between computing devices was enhanced further still. Although long-distance communications take place over the Internet backbone itself, which is separate from the PSTN, telephone lines are often still used to form a connection to a computer that itself is directly connected to (and in fact forms part of) the Internet itself. Such computers are often operated by an entity referred to as an Internet service provider (ISP).

One of the most popular communication services made available over the Internet is electronic mail, or “email”. Using this facility, subscribers can send text messages of almost any length to anyone else having an email address and a connection to the Internet. Even though email was (at least initially) limited to text transmissions, one reason for its popularity is readily apparent—it requires the availability of only one party at a time. The sender authors an email message at their own convenience and, although transmission can be almost instantaneous, the recipient reads the message whenever he or she is available. In addition, once a message is created, it can be both sent to almost any number of email-enabled recipients, and also forwarded by them to additional parties as well. It quickly became evident that as a mode of sending information, email was in some ways superior even to direct voice conversation.

Hampered by more limited transmission capacity, wireless cellular communication networks have been unable for practical reasons to emulate the ubiquitous email capabilities afforded to Internet users (though wireless email is currently available to a limited number of users possessing sophisticated devices). A substitute of sorts has evolved, however, and has gained rapidly in popularity. Generally referred to as short message service (SMS), this technology permits the transmission of text messages that are up to 190 characters in length. Though SMS messages are therefore relatively short in comparison to email's practically limitless capability, they are nevertheless sufficient in length to communicate basic information quickly. To effect more substantial communications, either a number of separate SMS messages may be sent in sequence, or else a single message may be used to direct recipients to a more copious source of information such as a World Wide Web site, or to a pre-recorded voice message stored in a telephone-accessible facility.

SMS also makes efficient use of system resources, taking advantage of a portion of the network also used for out-of-band signaling. Even though a voice conversation requires a dedicated facility—subscribers would never be satisfied with a system that stopped and started their conversation as channels became available—SMS messages can be sent on a one-way, briefly established channel when it is available. SMS messages are simply stored until a moment when space exists for transmitting them. SMS messages can even be sent to and from mobile stations (that is, cellular phones) that are otherwise using a dedicated channel for voice communication. This mode greatly increases the capacity of the network without requiring a large increase in network resources. The main disadvantage of SMS communication, aside from its limited message size, is that the text messages must be entered by typing. And in the mobile communications area, this typing must often be performed using an inadequately-sized keyboard such as the one on a mobile phone that has only fifteen to twenty keys.

Voice-mail systems have, of course, also become very popular. Whether in a home answering machine, an office PBX or key system, or even in wireless systems, storage devices with ever-increasing capacity permit a large number of users to have a “voice mailbox” that can hold many voice messages. (Such storage devices may be referred to as voice-mail servers.) Voice, after all, can communicate more richly than text, even if only heard through a recorded message. And in a way, stored voice messages emulate certain advantages of SMS. Only one party need be available at a time, and one-party messages can convey certain types of information more concisely than extended two-party (or more) conversations.

There even exist ways to make a single recorded voice message widely available, one such method being disclosed in U.S. Pat. No. 6,246,871, entitled “Method and Apparatus for Providing Access of Messages to Multiple Recipients in Cellular Networks.” As described there, a voicemail service may be provided with standard voicemail service and, in addition, the capability of accepting a user designation that selected voice messages are to be rendered accessible to other parties. A secret code is typically required to access the designated message, this code being provided to any intended recipients along with a telephone number to call in order to access the appropriate voice mailbox. Although a decided advantage over prior systems, this method nevertheless requires still that each recipient make a standard voice call to a central server to retrieve the stored message.

In this and other voice-mail systems, in other words, a complete network connection must still be established in most instances to leave (that is, record) the voice-mail message and also to listen to it. Although a certain brevity of speech may be of necessity introduced, roughly the same number of network connections are required as each intended recipient calls in, in turn, to retrieve the recorded voice message. Needed still is a way to exploit the quality of a voice communication while at the same time reaping the network-resource efficiency associated with some forms of text communications, such as SMS. The present invention provides just such a system and method.

### SUMMARY OF THE INVENTION

To overcome the above-described deficiencies in the prior art, the present invention provides a system and method for sending and receiving packetized short voice-message service (SVMS) messages over a wireless radio telecommunications network.

In one aspect, the system of the present invention includes a mobile station capable of digitally sampling an audio input and converting it into a digital packet formatted SVMS message for transmission. The mobile station includes sufficient memory to store the SVMS message until a data channel becomes available so that a voice channel is not used. The system further includes an SVMS gateway for receiving the SVMS message from the mobile station through the wireless telecommunication network. The SVMS message is routed by the SVMS-gateway to an SVMS-MSC, where it is stored until delivered to its intended recipient or discarded. Generally, a second mobile station capable of receiving, decoding, and playing the SVMS message is the intended recipient, but in one embodiment, the SVMS-MSC first determines whether the intended recipient has SVMS capability and, if not, attempts some alternate form of delivery.

In another aspect, the present invention is a method of transmitting an SVMS message through a wireless radio communication network including the steps of converting an audio message into an electronic packet-data format, transmitting the message over an available data channel to an SVMS-MSC, storing the SVMS message on the SVMS-MSC until the location of the intended SVMS message recipient can be determined. The method may further include the step of transmitting the SVMS message to the recipient if it can be located. The method may also include the step of determining whether the intended SVMS recipient is capable of receiving an SVMS message and, if not, pursuing an alternate form of message delivery.

### BRIEF DESCRIPTION OF THE DRAWINGS

FIG. 1 (prior art) is a functional block diagram illustrating an existing wireless radio telecommunication network, such as one that might beneficially adopt the system and method of the present invention;

FIG. 2 is a functional block diagram illustrating selected components of a wireless radio telecommunication system adapted for implementing a short voice-mail message service (SVMS) according to an embodiment of the present invention;

FIG. 3a is an illustration of an exemplary mobile station such as one that might be used to transmit and receive SVMS messages in a wireless radio telecommunication network such as the one illustrated FIG. 2, operable pursuant to an embodiment of the present invention;

FIG. 3b is a functional block diagram illustrating selected components of the mobile station of FIG. 3a, operable to send and receive SVMS messages according to an embodiment of the present invention;

FIG. 4 is a flow diagram illustrating an overall method of sending and receiving SVMS messages according to an embodiment of the present invention;

FIG. 5 is a flow diagram illustrating a method of sending SVMS messages according to an embodiment of the present invention;

FIG. 6 is a flow diagram illustrating a method of handling SVMS messages in an SVMS-server according to an embodiment of the present invention; and

FIG. 7 is a flow diagram illustrating a method of receiving SVMS messages according to an embodiment of the present invention.

### DETAILED DESCRIPTION OF THE INVENTION

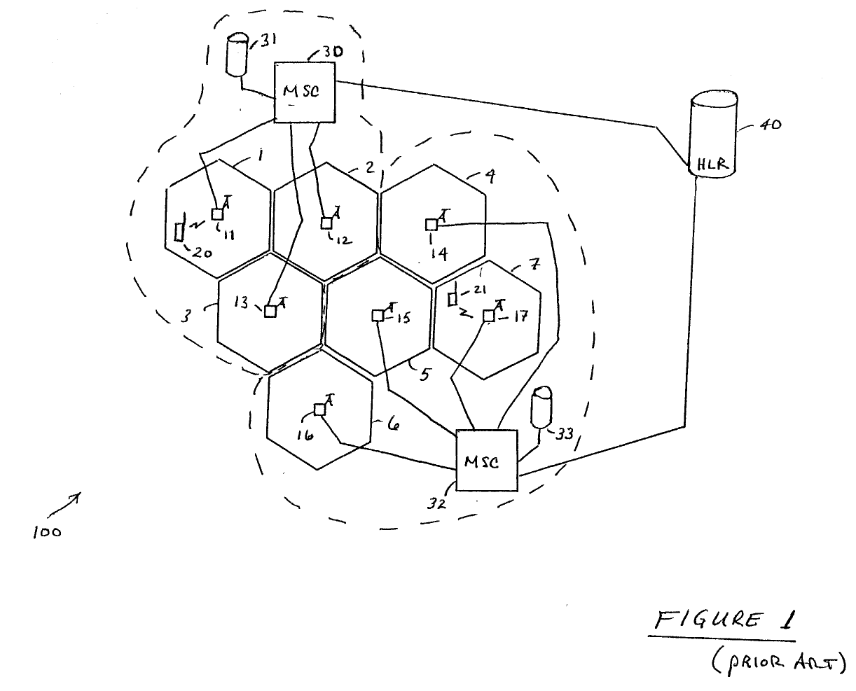

FIGS. 1 through 7, discussed below, and the various embodiments used to describe the principles of the present invention in this patent document are by way of illustration only and should not be construed in any way to limit the scope of the invention.

FIG. 1 (prior art) is a functional block diagram of an exemplary existing radio telephone communications network 100 such as one that may be advantageously adapted to employ the system and method of the present invention. The network 100 is divided into a multitude of areas such as cells 1-7, each associated with its own base-station subsystem (BSS) 11-17, respectively. Although only seven cells are shown, there are usually dozens in a network ranging in size from less than two to more than twelve miles across. A network may also have numerous smaller sub-cells or larger overlapping cells (not shown) each having their own BSS, in order to more efficiently handle rapidly moving communications traffic. A typical BSS may include an antenna and a transceiver for wireless communication with mobile stations, and also a base-station controller (individual BSS components not shown).

Each BSS is connected to the network through a mobile switching center (MSC). This connection may be made by wire, or by some other high-capacity means. For example, in the embodiment of FIG. 1, BSSs 11-13 are connected with MSC 30, and BSSs 14-17 are connected with MSC 32. MSC 30 and MSC 32 are also associated with visitor location register (VLR) 31 and VLR 33, respectively. VLR 31 and VLR 33 are data storage devices where MSC 30 and MSC 32 store information relating to wireless activity in their respective MSC/VLR service area (delineated by broken lines in FIG. 1). One or more, and usually many MSC/VLR service areas make up the wireless network 100, which is sometimes referred to as a public land mobile network (PLMN). A wireless service provider may have several PLMNs. Each PLMN has an HLR, such as HLR 40, which communicates with the individual MSCs and maintains information concerning the network itself and its subscribers.

Each individual subscriber connects to the network 100 using a radio transceiver often referred to as a mobile station (MS). MS 20, for example, is a cellular phone, which although they are the most common form of MS in use today, other types are already in use and gaining popularity. For example, a personal computer (PC) or personal digital assistant (PDA) (not shown) may also be equipped with circuitry providing the ability to communicate with the wireless network 100. Mobile stations are usually, as the name denotes, mobile. They make contact with network 100 through the BSS that covers the area in which they are currently located. Since more than one BSS is usually in range of a given mobile station at any one time, the one receiving the strongest signal will generally be used for the connection. When an MS relocates during a transmission so that another BSS becomes the most appropriate, the connection will be switched, what is commonly referred to as a ‘hand-off’. Ideally, a connection to the second BSS will be established before the connection to the first BSS is broken off, and in this way the subscriber perceives no discernible break in the conversation.

HLR 40 maintains in its database subscriber profiles that contain information about each subscriber. The information will include, for example, the subscriber's mobile-station identification number (MSID) or code, the specific services subscribed to, and other subscriber information. The HLR 40 may also maintain in its database the area or cell in which each subscriber's MS, such as MS 20 and MS 21, are currently located. The HLR 40 database is therefore useful when it becomes necessary to authorize and locate MSs.

The location of an MS such as MS 20 is usually determined through a process called registration, where the MS 20 transmits its MSID when it is turned on, and periodically thereafter, so as to alert MSCs within range (here MSC 30) to its presence. Naturally, when the MS moves from place to place, the registration process enables other MSCs to detect its location in their respective MSC/VLR service areas. From time to time, each MSC reports registration information stored in its VLR to HLR 40. The HLR 40 then stores this location information in case it is needed to route a transmission to MS 20. The HLR 40 may also receive and store a record, if applicable, that MS 20 has roamed beyond the PLMN, and through which other network contacts may be made through a gateway mobile switching center (GMSC) (not shown), assuming that MS 20 has registered its MSID and home PLMN information there. For example, MSC 32 may receive notice that a transmission to MS 20 is being attempted. If MS 20's current location is not stored in VLR 33 (or if an attempt to contact MS 20 at its last-known location has failed), then MSC 32 may send a query to HLR 40 to ascertain the location information. If the information is not there, HLR 40 may query other MSCs in the PLMN in an attempt to find it. Eventually, either the correct location information is obtained and thereafter the appropriate connection made, or a determination is made that MS 20 cannot currently be found and the attempted transmission is aborted.

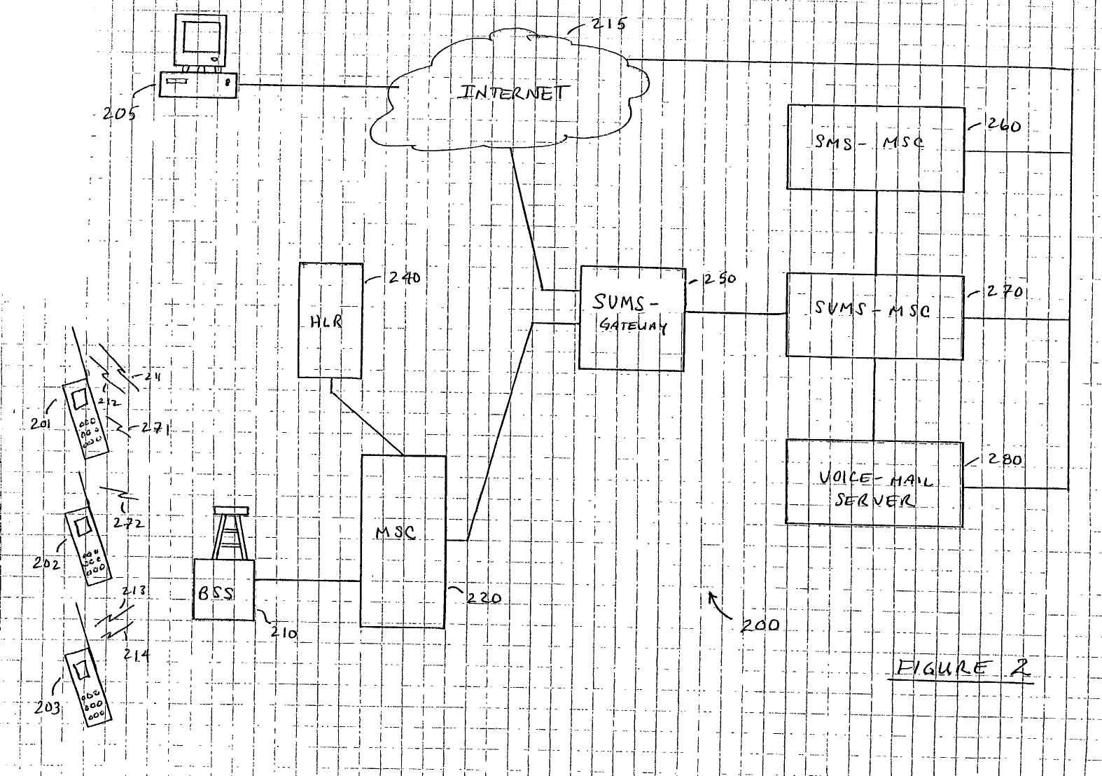

FIG. 2 is a functional block diagram illustrating selected components of a wireless radio telecommunication system 200 adapted for implementing a short voice-mail message service (SVMS) according to an embodiment of the present invention. It is an object of the present invention to enable the efficient transmission of SVMS messages from one communication station to one or more others over a radio telecommunication network. Note that none of these stations are required to be a portable or wireless device, excepting that wireless radio communication networks are generally not used absent the need to transmit to or from such a device. With this understanding, the present invention will, for convenience, be described here in the context of sending a SVMS from a first mobile station (for example, a cell phone, PC, or PDA) to one or more other mobile stations, or alternately, from a computer to one or more mobile stations through an Internet connection. Other combinations are possible, however, but their equivalence should be apparent in light of the present disclosure.

Just as described in reference to FIG. 1, mobile stations, here MS 201, 202, and 203, connect through base station system (BSS) 210 to MSC 220. Exemplary communication links are shown as lightning bolts. MS 201 has established a voice channel with BSS 210 comprising forward link 211 and reverse link 212. The same is true of MS 203, which is utilizing forward link 213 and reverse link 214 for the purpose.

Currently, there are two channels for communicating through a wireless network; a voice channel (analog or digital) and a data channel (digital networks only). A voice channel requires a dedicated circuit to utilize a full-duplex voice path. This real-time connection requires more bandwidth than a SVMS-MSC 270 non-real-time channel, because live conversations require two-way (full duplex) communication.

A data channel can be implemented over a packet-data network using GPRS or a similar service, providing non-real-time delivery of data messages. Information is transferred upon a load basis, where intelligent loading schemes can be optimized for cost-effective delivery. The system and method of the present invention sends a digitized SVMS message for delivery over the data channel network. The half-duplex voice message is delivered in non-real-time mode. Note that for this reason, SVMS messages can be delivered on either a point-to-point basis or on a point-to-multipoint basis. (The latter also being known as ‘dispatch’.)

Referring again to FIG. 1, MS 201 and MS 202 are shown communicating data to BSS 210 over data channels 271 and 272, respectively. As mentioned above, these channels are only opened on an ad hoc basis, and usually for a very short time when a needed channel becomes available, and do not remain open as do voice channels.

MSC 220 is in communication with HLR 240. Although a single BSS and MSC are shown in FIG. 2, there will usually be many in particular wireless PLMN. Note that personal computer (PC) 205 is shown connected to the network via the Internet, and is therefore, in this instance not necessarily considered a mobile station. In other words, PC 205 is considered a mobile station when it uses a wireless channel to connect to the network, and as such may send and receive SVMS messages. Note that in an alternate embodiment, PC 205 may send an SVMS message to mobile stations through an Internet connection. The Internet connection may in fact be made through a wireless radio frequency (RF) connection to a BSS (and then through an Internet gateway), but may also be made through a dial-up connection to an ISP, or through some other Internet connection.

In the wireless network of FIG. 2, voice-communication conversations are connected and conducted in the usual fashion, explained in reference to FIG. 1, above. In accordance with the present invention, however, MSC 220 is also connected to a SVMS-gateway 250. Although a single MSC is shown in FIG. 2, SVMS-gateway 250 will very likely be connected to a great many. SVMS-gateway 250 is also in communication with a short message service MSC (SMS-MSC) 260, a short voice message MSC (SVMS-MSC) 260, and a voice-mail server 280. Although shown as three separate components, note the SMS-MSC 260, the SVMS-MSC 270, and the voice mail server 280 may alternately be housed in the same physical unit, perhaps sharing some functional components. Note also that although these components will generally need to be added to an existing wireless network, such as network 100 shown in FIG. 1, advantageously the basic network does not require significant alteration.

SVMS-gateway is a gateway having enhanced data handling ability. It may, for example, be a GPRS-gateway, also other enhance-data services may be used as well. General packet radio service (GPRS) is a relatively new wireless service for use in digital cellular networks, such as GSM. Using radio transmitted packets, it is capable of carrying the user's packet-data from one GPRS to another. GPRS uses a packet technique to transfer data outside of the normal voice communication channel, in a manner similar to the way SMS messages are transmitted. SVMS messages may be sent via GPRS because they are transmitted in packet format and do not need to be sent in real time. Again, although transmission of SVMS messages may be very rapid, the messages will not be transmitted as soon as they are generated, but rather as soon as transmission space is available. In this way, an SVMS-capable system can send voice messages while realizing similar out-of-band transmission efficiencies as are obtained in sending SMS messages. Not previously available, GPRS is now gaining ground as the service of choice in many wireless networks. Its primary use is to transmit user data (such as IP and X.25) and can be used for many other types of data communication, as well. The system and method of the present invention takes advantage of the GPRS technology. In order to transmit and receive GPRS messages, however, the mobile station must be properly equipped to do so. And, as previously mentioned, although GPRS is preferred, and service capable of sending SVMS packet data may be used instead. All such services will for convenience herein be referred to as “enhanced data” or “enhanced packet data” services. Where SVMS and SVMS messages or system components are referred to, they will be considered to use or be capable of using enhanced packet data.

Returning to the embodiment of FIG. 2, when MSC 220 receives an SVMS communication through BSS 210, it recognizes the nature of the transmission and forwards the SVMS message to SVMS-gateway 250. The SVMS-gateway 250, in turn, forwards the SVMS message to SVMS-MSC 270, where it is stored until it can be transmitted to its intended recipient. This recipient may be, for example, mobile station 202, in which case, the SVMS message is transmitted back through SVMS-gateway 250 and MSC 220, BSS 210, and finally to MS 202. Note that in some wireless networks, a voice-channel conversation between two MSs currently being served by the same MSC may be switched by that MSC, meaning that no voice channel need be established through a higher network level. Most existing MSCs, however, will not without modification be able to store and route SVMS messages even to other MSs in their own service area.

If MS 201 and MS 202 are located in different MSC/VLR service areas, on the other hand, then the SVMS message will be sent through the appropriate MSC (not shown) and, if necessary, through a separate gateway (or gateways, also not shown) to a different wireless network. In order to send the SVMS message to target MS 202, the SVMS-MSC 270 first determines whether MS 202 has SVMS capability. It may, for example, have such information already stored in an SVMS-register (not shown) of its own, or it may query HLR 240 for the information. In accordance with a preferred embodiment of the present invention, HLR 240 maintains information relating to the capabilities of mobile stations registered there. The HLR 240 information about a given mobile station is specific enough to determine whether the subscriber utilizes a voice-mail feature, or whether the mobile station has SVMS capability. As will be described in more detail below, if MS 202 is not capable of receiving an SVMS message, the SVMS message may be stored as a voice-mail in voice-mail server 280 or made available to MS 202 in some other fashion.

In one embodiment, PC 205 is itself actually a mobile station in the wireless network 200, and in that case it to sends an SVMS message in basically the same way as does, for example, MS 201, through an available wireless network data channel. PC 205 may also use its Internet connection to locate and contact a server in communication with network 200, possibly through a World Wide Web site. The server it contacts may, in fact, be SVMS-MSC 270, or may be a different server (dedicated or shared with another function) designed for serving this purpose. In either case, SVMS messages generated by PC 205 eventually reach SVMS-MSC 270 and handled as any other SVMS message.

In a particularly preferred embodiment, PC 205 may also send an SMS message to SMS-MSC 260, that instead of being delivered in the normal fashion, is sent to a text-to-speech (TTS) converter (not shown). There, it is converted there into a packet-format SVMS message, which is then forwarded to SVMS-MSC 270 for delivery. In other words, to PC 205 it will appear that a standard SMS message is being sent to MS 202, even though MS 202 will actually receive the communication as a SVMS message. The conversion, of course, may be requested by the user of PC 205, or by the subscriber associated with MS 202 (who presumably has indicated in advance that they wish to use this conversion to SVMS if it is available). In this embodiment, the SMS message may also be sent along with the SVMS message, or it may be discarded once the SVMS message is delivered. In yet another embodiment, for example where recipient MS 202 is not SVMS capable, the SMS message may be converted into a voice-mail message by the TSS, and then stored on voice-mail server 280, either with or without delivery of the SMS message itself.

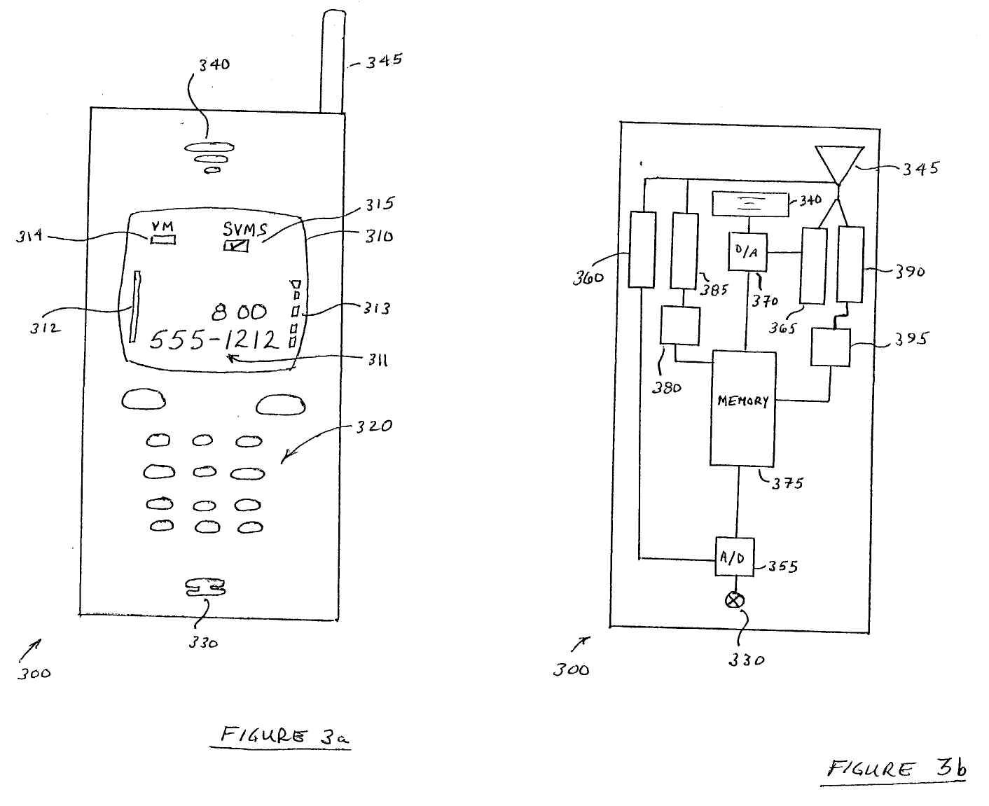

FIG. 3a is an illustration of an exemplary mobile station (MS) 300 such as one that might be used to transmit and receive SVMS messages in a wireless network such as network 200 illustrated in FIG. 2, operable according to an embodiment of the present invention. Note that MS 300 is illustrated as a mobile, or cellular phone, though it could also be a PDA, PC, or similar device capable of wireless communication. MS 300 includes display 310 on which may be shown, for example, a called number 311, system status indicators 312 and 313, and message waiting indicators 314 and 315. MS 300 also includes a keypad 320 for entering information. Actual voice communication is conducted using microphone 330 and speaker 340. Radio transmission to a BSS is facilitated through antenna 345.

FIG. 3b is a functional block diagram illustrating selected internal components of the MS 300 of FIG. 3a, operable to send and receive SVMS messages according to an embodiment of the present invention. Microphone 330 is connected to a converter 355 that converts a received analog signal into digital form. The digital signal is ordinarily provided to voice transmission circuitry 360 to be sent over an established voice channel through antenna 345. Return transmissions along this channel are picked up by antenna 345 and provided to receive circuitry 365, which produces a demodulated digital signal that it provides to converter 370 to be converted to an analog signal that can be ‘played’ on speaker 340. This description is intended to be exemplary and not limiting, and the same basic functions may be performed by circuitry described in a different way. In an analog network, of course, conversion to digital is not required for ordinary voice conversations. MS 300 also includes components for sending and receiving SVMS messages, including buffer memory 375. Note that conventional cell phones will include some memory capacity, but typically an enlarged data storage facility will be required in order to use SVMS. Memory 375 stores digital representations of SVMS messages input by the subscriber. From memory 375, the SVMS message is sent to packet-forming circuitry 380. The data packets are then provided to SVMS transmission circuitry 385 and transmitted over an available data channel. Received SVMS transmissions are provided by antenna 345 to SVMS receive circuitry 390, which in turn provides the SVMS message in packet form to packet disassembly circuitry 395. The received SVMS message is stored in memory 375 until the subscriber asks for it to be played.

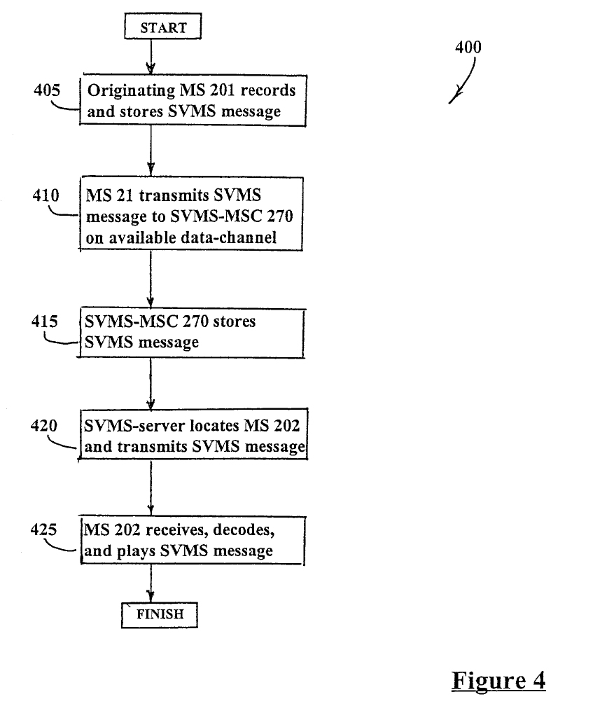

FIG. 4 is a flow diagram illustrating an overall method 400 of sending and receiving SVMS messages according to an embodiment of the present invention. Initially (START), it is presumed that a radio telecommunications system employing an enhanced data-handling solution such as GPRS has been deployed, such as the system 200 illustrated in FIG. 2. In the embodiment of FIG. 4, an originating MS 201 sends a SVMS message to a terminating MS 201, both MSs being GPRS capable. Such communication stations are currently available, although not yet in universal use. Originating MS 201 first records and stores a SVMS message (step 405). MS 201 then requests a data channel, and when one is available, transmits the stored SVMS message to an SVMS-MSC 270 through the nearest (or otherwise most appropriate) BSS 210 and SVMS-gateway 250 (step 410). Note that this SVMS transmission may take place regardless of whether the originating MS 201 is conducting a voice conversation over a voice channel. The MS 201 will, however, have to be powered up, although in a preferred embodiment, the MS will be capable of entering a standby mode where most functions are turned off except those required for sending and receiving SVMS messages (and presumably SMS messages as well).

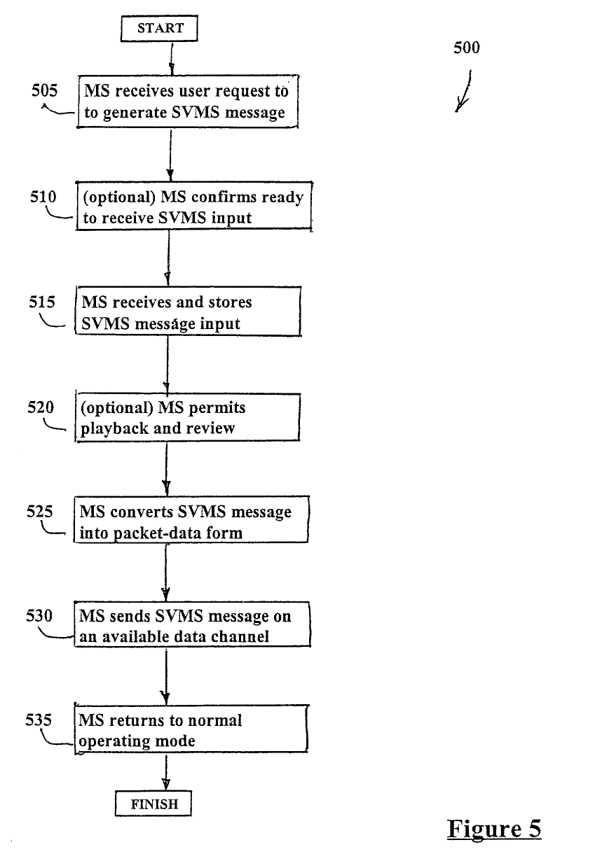

After it is transmitted, the SVMS message is received and stored in the SVMS-MSC 270 (step 415). The SVMS-MSC 270 then attempts to locate the terminating MS and, when it does so, transmits the stored SVMS message through an SVMS-gateway and the appropriate BSS 210 (step 420). If it fails to locate the terminating MS, the SVMS-server may make further attempts at periodic intervals for a pre-set amount of time. If still not successful, the SVMS message may be discarded as undeliverable. Assuming the transmission is successful, however, the terminating MS 202 receives, decodes, and, when instructed to do so, plays the SVMS message (step 425). Typically, the terminating MS 202 will also store the received SVMS message at the mobile subscriber's discretion. This overall method 400 of transmission will now be described in greater detail in FIGS. 5-7. Note that in some variation in each of these embodiments is permissible consistent with the system and method of the present invention, and that the steps of each method and the order in which they are presented are exemplary. In practicing the disclosed invention, the method steps may also be performed in any other logically-consistent sequence.

FIG. 5 is a flow diagram illustrating a method 500 of sending a short voice message service (SVMS) message according to an embodiment of the present invention. At START, it is presumed that the originating mobile station is capable of sending SVMS messages and that the wireless network is capable of processing them. The process begins when the mobile station receives a request to generate an SVMS message. This request, of course, will generally come from the user (subscriber), and will generally be sent by either depressing a special, dedicated SVMS ‘record’ key, or on a device not so equipped, by depressing the keys in a predetermined sequence, for example “*76” (step 505). In an alternate embodiment, the SVMS message generation process is initiated by either a voice command, or a response to some form of prompt delivered by the MS itself. For example, an individual whose job requires regular but short progress reports or status reports may be able to program an appropriately equipped mobile station to notify him when a report is needed. Upon hearing some sort of prompt, for example a loud tone, he could simply begin his report and indicate when it's ready to be transmitted. In any event, in most cases it will be preferable, although optional, for the mobile station to issue some form of confirmation that it is ready to receive SVMS input. This confirmation could be done by an appropriate notation displayed on the mobile station display, or ideally by an audio confirmation tone delivered to a subscriber that presumably has already raised a mobile station, such as a cellular phone, in order to begin speaking (step 510). Next, the mobile station receives an audio signal from the subscriber, and stores the audio signal in a buffer memory (step 515). Generally, the audio input will be converted into digital form as it is received using a sampling technique, although other forms of storage may be used if available.

Although the review step in this process is optional, it is highly preferable during the review step 520 the subscriber may, by using dedicated keys or predetermined key strokes, indicate that the message should be played back for review, deleted and rerecorded, or, to the extent the mobile station is capable of doing so, partially, but not completely revised. At this step 520, the subscriber may also indicate that the voice SVMS message should be stored only, that is, not immediately transmitted. This option allows the user to record a voice message and send it at a later time. In an alternate embodiment, the user may select the option of saving the recorded message and sending it to a special server where it can be stored until recalled by the subscriber for transmission in the normal fashion (including any desired review, playback, or revision). The mobile station then converts the digital data into a packet-data format for transmission (assuming that this has not already been accomplished as part of a previous step) and stores the results in memory to await transmission (step 525).

As mentioned previously, in order to conserve network resources, the SVMS message is not sent immediately by a dedicated voice channel established for this purpose. This being the case, it is necessary for the mobile station to monitor the airwaves for an available data channel. The data channel is one where transmissions are not sent in ‘real-time’, and is therefore used for signaling and data transmission, but is not suitable for ordinary conversation. When a data channel does become available, the MS sends the SVMS message to the indicated recipient (step 530). The MS then returns to normal operating mode (step 535), and optionally makes a SVMS log notation (step not shown) indicating when and to whom the voice-mail was sent.

Addressing the SVMS message (step not shown) is accomplished at some point during the above process by indicating the telephone number of the intended recipient or, if available, a Web, email, or alternate form of address. In one embodiment, the mobile station queries the user for the address of the intended recipient when a request to generate a SVMS message is received. In another embodiment, the mobile station asks for recipient information only after the subscriber indicates that the message has been satisfactorily generated and needs to be sent. In a particularly preferred embodiment, the MS both plays back the recorded SVMS message, and asks the user to confirm that the message should be sent to the following recipients. Note that in the system and method of the present invention, it is possible to send a SVMS message to more than one recipient to take advantage over prior art forms of voice messaging.

One of the key features, of course of the SVMS is its ability to effect point-to-multipoint (dispatch) transmissions. A subscriber sending a SVMS message to multiple recipients will generally indicate their identity initially. In some cases, however, this is not feasible. For example, a manager wishing to disseminate by voice a certain instruction may not remember or have in an address book the contact numbers for all affected employees. The message can nevertheless be sent to those whose numbers are known, but accompanied by a command to save the SVMS message on the SVMS-MSC 270. When the contact numbers are learned, the message can simply be recalled and transmitted to additional recipients. The same basic process would be an advantage where, for example, the same message is originally sent to a limited number of recipients, who may be able to address themselves whatever imperative the SVMS message contains. If not, the distribution list could be widened.

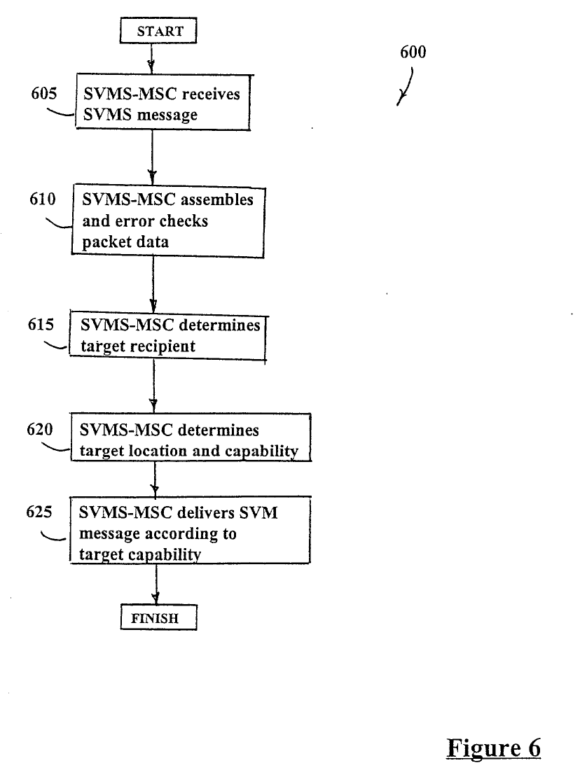

FIG. 6 is a flow chart illustrating a method 600 of processing a SVMS message in a SVMS-MSC 270 in accordance with an embodiment of the present invention. Initially (START), the SVMS-MSC 270 has been connected to the wireless network through a gateway, such as SVMS-gateway 250 shown in FIG. 2. The method begins when the SVMS-MSC 270 receives an SVMS message (step 605). As with any recipients of a packet-data transmission, the SVMS-MSC 270 assembles the packets relating to one particular message in order, and checks the transmission for completeness and forms any other desirable error-checking functions (step 610). Having assembled the message, the SVMS-MSC 270 determines the identity of the target recipient of the SVMS message (step 615). The SVMS-MSC 270 proceeds to determine the location of the intended recipient, as well as its capability to receive a SVMS message (step 620). The SVMS server accomplishes this step by sending a query to the HLR 240 where the originating mobile station 201 is registered (as determined by the MSID transmitted in the packet-data transmission). Upon receiving a response, the SVMS-MSC 270 delivers the SVMS message according to the target recipient's capabilities (step 625). Note that the SVMS-MSC 270 may send a given SVMS message in more than one fashion, in a system permitting such, if requested by the sender or otherwise determined from the circumstances. At this point, the SVMS-MSC 270 may delete the message from its database, but more frequently will retain the message at least until receipt by the intended recipient is confirmed.

Note that again the SVMS message is transmitted to the recipient mobile station 202 on a data channel, which may not become available immediately and, therefore, is saved on the SVMS-MSC 270 until such time as capacity for transmission is available. Optionally, the SVMS-MSC 270 retains the message and waits to receive a disposition request instructing it to delete, save, or send the message somewhere else. As it is frequently expected in a system operating in this manner, the recipient, once the message is received, may desire to forward the message to another or send a reply to the originating mobile station 201. In either case, it may be advantageous to simply receive a request to send the SVMS message to another recipient (or to the original sender), and instead of receiving the original message again from the (now) recipient, the SVMS-MSC 270 can simply use the copy of the message already stored in its database. Of course, if the original SVMS contains a request that it be sent to more than one recipient, the process above is repeated as many times as necessary to effect delivery to each of the recipients, each of them in turn can indicate a desire to reply to, or forward the message.

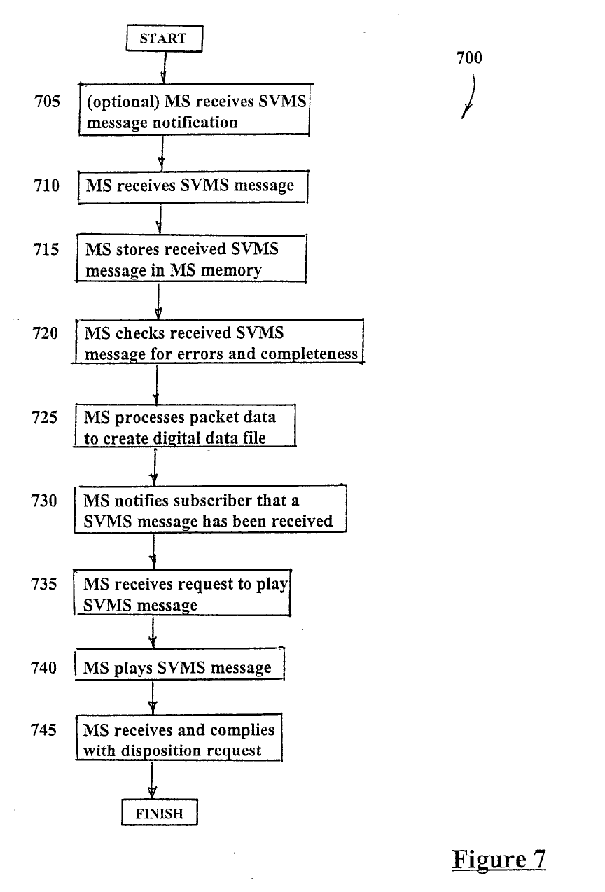

FIG. 7 is a flow diagram illustrating a method 700 of receiving in a mobile station an SVMS message according to an embodiment of the present invention. When the process begins (START), it is presumed that an SVMS message has already been sent and resides on the SVMS-MSC 270 awaiting delivery. The SVMS-MSC 270 has also conducted its query (described above in reference to FIG. 6) to determined that the mobile station in question is actually capable of receiving a SVMS message. Preferably, delivery commences by first transmitting a notification through the data channel to the intended recipient to let them know that a SVMS message is awaiting delivery. The intended recipient MS 202 is presented with an opportunity to accept, reject, or delay delivery of the message (step 705). As the caller ID feature is now ubiquitous, the intended recipient may make this decision based on the actual identity (or lack thereof) associated with the awaiting SVMS message. In another embodiment (not shown), a separately generated SVMS message is automatically sent to the intended recipient, who is appropriately alerted to its presence, the separate SVMS message simply indicating that there is another, that is, the actual message, awaiting delivery. If possible, the identity of the sending station (which was perhaps separately collected and formed into a SVMS message at origination) is also presented to the intended recipient.

In any event, when the intended recipient indicates a willingness to receive the stored SVMS message, it is sent by the SVMS-MSC 270 as soon as the data channel is available for doing so, and received in the recipient's MS 202 (step 710). MS 202 then stores the message in its own memory storage device (step 715). The recipient MS 202 then performs its own confirmation that all of the packets making up the SVMS message are delivered and free of errors (step 720). The stored packets are then processed to create a usable, digital data file (step 725). Once the SVMS message has been received and stored appropriately, the mobile station provides the subscriber with some sort of confirmation that they may now listen to the SVMS message (step 730). This may be done by simply posting on a display associated with the mobile station a notice that a SVMS message is ready to be played, or an audio tone or ring may be used. Note that the mobile station may be equipped to deliver a specialized tone or ring to indicate that the SVMS message is from a known (or, on the other hand, unknown) person. The mobile station may also be able to comply with a request to let the subscriber know the priority with which the message is sent, whether a reply is requested, the amount of time remaining to satisfy the reply request. MS 202 then receives, presumably, from the user a request to play the SVMS message (step 735). The message is then played for the subscriber (step 740). After the message has been played for the subscriber, the mobile station receives a disposition request from the subscriber. Note that for purposes of simplicity, the lack of any indication by the subscriber of what should be done with the message is considered one such disposition request. Presumably having received no indication as to what to do with the SVMS message, the mobile station 202 simply retains it as long as there is room in memory for storage. The subscriber may also send a disposition request indicating that the message should be saved, with the same result, or deleted. The subscriber can also ask that the message be saved to a server, assuming that service is available in wireless network 200, or forwarded to another recipient, or a reply sent to the original sender (process step 745).

If the SVMS-MSC 270 cannot deliver the SVMS as described above, it may pursue an alternate delivery method (not shown). For example, it may wait until the target station becomes available and then establish a standard voice connection, with itself as the calling party and the target station as the called party. When the target station completes the connection by going off hook, the SVMS server converts the stored SVMS from packet form to audio form and transmits the audio signal. Preferably, an introductory message is sent first, one that is either pre-recorded or one that is generated for this call. A combination of the two introductions may also be used, for example, to transmit a prepared message interrupted to transmit a generated audio report of the number of the calling party. In another embodiment, the SVMS is sent to a voice message server where it is stored in a standard voice message format. The SVMS-MSC 270 also sends a notification to the target station, for example, by short message service (SMS) or by a notification that a message is waiting, if the target station has voicemail capability. If not, the intended recipient could be sent an access number and PIN to retrieve the message.

In one alternate embodiment (not shown), an SVMS message is converted by a voice-recognition device into a text message, perhaps to be delivered as an email or SVMS message. Generally, this would not be a preferred method, except in that a written record may be preferred by some recipients. If available, some other form of packet-data to voice conversion could also be used, including transmission to a service that employs a human operator for the task (listening to the SVMS and transcribing it).

Organizational features may also be added, such as an address book (on the MS or an accessible server), and an SVMS file-folder type storage system. Alternative devices may be developed for use especially with SVMS, such as a personal recording device (PRD) that is able to record and store voice memos, and which is capable also of communicating SVMS messages. The PRD may not, in all cases, include the ability to make standard voice calls. Such a service might be made available to subscribers at a lower cost, since data channel communication imposes a far lower burden on network resources than voice channel conversation.

The SVMS described above may be advantageously used in a number of applications. For example, a Web site or other portal may be used to send standardized or customized messages. A retailer may be able to simply finish an order by clicking on a button that sends an SVMS message to a buyer notifying them of shipment. Or specialized “push” SVMS messages may be used for advertising. In a preferred embodiment, a subscriber may access a portal Web site and select a service that automatically generates and transmits to them SVMS messages of relevance, such as one notifying them of adverse traffic conditions on a certain highway during rush hour. The Web or portal site server simply causes the appropriate message to be sent out through a gateway to an SVMS-MSC for delivery. A special tone, ring, or vibration alert may be used to let the subscriber know this type of SVMS message is being delivered.

The preferred descriptions are of preferred examples for implementing the invention, and the scope of the invention should not necessarily be limited by this description. The scope of the present invention is defined by the following claims.

1. A system for transmitting short voice message service (SVMS) messages to an intended recipient through a radio communication network, said system comprising:
a first communication station, comprising:
a packet-data generator for converting an SVMS message into a packet-data format for transmission; and
a storage device for electronically storing the SVMS message until it can be transmitted to an SVMS-MSC; and
an SVMS-MSC for receiving the packetized SVMS message and storing it until it can be transmitted to the intended recipient.

2. The system of claim 1, further comprising a microphone in the first communication station for receiving an audio input, converting it into electronic signals, and providing the electronic signals to the packet-data generator.

3. The system of claim 1, further comprising a text to speech (TTS) converter in communication with the first communication station for converting a text file into digital audio form and providing the digital audio signal to the packet-data generator.

4. The system of claim 1, wherein the intended recipient is a mobile telephone, and said system further comprises a home location register (HLR) for storing information regarding the mobile telephone.

5. The system of claim 4, wherein the SVMS-server queries the HLR to determine if the mobile telephone is SVMS capable.

6. The system of claim 5, wherein the SVMS-server, upon receiving a response from the HLR indicating that the mobile telephone is not SVMS capable, delivers the SVMS message by an alternate delivery method.

7. The system of claim 5, further comprising a voice-mail server in communication with the SVMS-MSC and accessible to the subscriber, and wherein the alternate delivery method includes storing the SVMS message as a voice-mail message on the voice-mail server.

8. The system of claim 4, wherein the SVMS-MSC queries the HLR to determine the location of the mobile telephone.

9. The system of claim 1, wherein the first communication station is connectable to the Internet such that the SVMS message may be transmitted to the SVMS-MSC through the Internet.

10. A method of enabling the transmission of an SVMS message from an originating station to a target station through a wireless telecommunication network, said method comprising the steps of:
receiving an SVMS message in packet-data format in an SVMS server;
storing the SVMS message in a data storage device in communication with the SVMS server;
determining a transmission path to the target station for delivering the SVMS message; and
transmitting the SVMS message.

11. The method of claim 10, further comprising the step of verifying delivery of the SVMS message to the target station.

12. The method of claim 11, further comprising the step of sending a delivery confirmation notice to the originating station, upon verifying delivery.

13. The method of claim 10, further comprising the step of determining if the target station is SVMS capable.

14. The method of claim 13, wherein the step of transmitting comprises transmitting the SVMS message to the target station upon determining that the target station is SVMS capable.

15. The method of claim 13, wherein the step of transmitting comprises transmitting the SVMS message to a voice-mail server for storage.

16. The method of claim 15, further comprising the step of sending to the target station a notification that the SVMS message was transmitted to a voice-mail server.

17. The method of claim 10, wherein the SVMS message is received from an SVMS portal.

18. The method of claim 18, wherein the SVMS portal is a World Wide Web site accessible by subscribers to direct that an SVMS message be generated upon the occurrence of a certain event.
